(19) United States
(12) Patent Application Publication
(10) Pub. No.: US 2026/0358218 A1
(43) Pub. Date: Nov. 12, 2026

(54) Test Chamber Assembly and Capillary Rheometer with a Test Chamber Assembly

(71) Applicant: Netzsch-Gerätebau GmbH, Selb (DE)

(72) Inventors: Simon Popp, Streitau (DE); Georg Neumann, Schönwald (DE); Christian Müller, Höchstädt (DE)

(21) Appl. No.: 19/651,981

(22) Filed: Apr. 20, 2026

(30) Foreign Application Priority Data
May 6, 2025 (DE) 10 2025 117 322.2

(51) Int. Cl. G01N 11/04

(52) U.S. Cl. CPC G01N 11/04

(57) ABSTRACT

A test chamber assembly, in particular in a capillary rheometer, including a test chamber, which can be filled with a test mass and is in particular heatable, having a test chamber base; a die arranged to be linearly displaceable within the test chamber, having a die rod and a die tip connected to a first end of the die rod, which applies pressure to the test mass and has a die base; a displacement device receiving a second end of the die rod for displacing the die in the test chamber in the direction of the test chamber base; and a non-contact distance measuring device arranged in the displacement device, decoupled from the die and movable with the displacement device, for detecting die elongation, wherein a bore extending in the direction of a longitudinal axis of the die rod between the die base and the second end is formed in the die rod, and wherein a reflective surface facing the non-contact distance measuring device is provided at the die base for a measurement signal emitted by the non-contact distance measuring device through the die rod, and the non-contact distance measuring device comprises a sensor arranged opposite the reflective surface for contactless detection of the measurement signal (MS) reflected from the reflective surface to the sensor, as well as a capillary rheometer with such a test chamber assembly.

### TECHNICAL FIELD

The present invention relates to a test chamber assembly, in particular in a capillary rheometer, and to a capillary rheometer comprising such a test chamber assembly.

### BACKGROUND

Capillary rheometers are used to investigate the flow behaviour and rheological properties of viscous and plastic materials, for example polymers and highly viscous fluid systems. The material to be investigated is passed through a test chamber under defined pressure and, as a rule, at a constant temperature, and can subsequently be extruded from a nozzle. During flow through the test chamber, measurements are taken of the pressure at the inlet of the capillary and the resulting flow velocity of the material. By varying the pressure and measuring the corresponding volume or mass flow rate, the shear rate and shear stress of the material can be determined. Data on viscosity can be derived from the relationship between shear stress and shear rate and analysed at different shear rates. This allows the flow behaviour of the test material to be modelled under realistic process conditions and a rheological characterisation of polymer melts and paste-like systems to be carried out. The data obtained on the temperature and shear rate dependence of viscosity serve as a basis for process design, such as in the injection moulding and/or extrusion of plastics.

Capillary rheometers with specially designed test chambers enable pVT measurements by determining the volume between a nozzle and the tip of a die, which is used to force the test material through the test chamber under pressure and extrude it from the nozzle. Due to high process temperatures of up to 500 °C and high prevailing pressures, both the die and the test chamber undergo thermal and mechanical strains, which distort the measurement results and must be compensated for in the measurement data. One method for measuring strain is the use of strain gauges. However, these are of limited applicability with regard to the temperature range. Furthermore, the heating of the die and thus its temperature-induced strain is not uniform, meaning that strain measurement would require significant design effort through the use of strain gauges attached at multiple positions. An alternative, purely mathematical compensation for the expansion of the die and test chamber can only be carried out with great effort, as the heating process is both transient and inhomogeneous, i.e. time-and location-dependent. Given the typically wide temperature and pressure range in rheological measurement, this results in a multidimensional system/matrix of dependencies, which could only be adequately determined with a very high computational effort. Furthermore, a completely new calculation would be required if design changes were made (e.g. changes to the dimensions, material, or geometries of the die and/or test chamber). In addition, the computational compensation is far less accurate, which is partly due to the large number of joints between the individual components within the area of the test chamber assembly under consideration. The heat transfer at these points, known as the joint thermal conductivity or contact resistance, is difficult to determine mathematically and requires experimental verification. However, the joint thermal conductivity has a major influence on the heat flow within assemblies and thus also on the temperature within them, which has a direct effect on thermal expansion. On the other hand, both the local heat input is inhomogeneous and the heating process is transient, which means that large parts of the surrounding structure would also need to be co-simulated if expansion compensation were to be performed solely by calculation. This makes the simulation setup very complex; combined with the transient nature of the process, this results in long calculation times. In addition to thermal influences, mechanical factors also come into play; for example, the modulus of elasticity is temperature-dependent, which affects the shortening of the die as a result of the spindle force. These factors would also need to be taken into account in numerical compensation in order to achieve a usable result using theoretical methods.

### SUMMARY

It is therefore the object of the present invention to provide means for carrying out strain compensation in the test chamber of a capillary rheometer in a more cost-effective, simpler and more accurate manner.

According to the invention, this object is achieved in each case by the subject matter of the independent claims.

According to a first aspect of the invention, a test chamber assembly is provided, in particular in a capillary rheometer. The test chamber assembly comprises a test chamber which can be filled with a test mass and in particular is heatable, having a test chamber base, a die arranged to be linearly displaceable within the test chamber and comprising a die rod and a die tip connected to a first end of the die rod which applies pressure to the test mass and has a die base, and a displacement device receiving a second end of the die rod for displacing the die in the test chamber towards the test chamber base; and a non-contact distance measuring device arranged in the displacement device, decoupled from the die, displaceable with the displacement device, decoupled from the die, wherein a bore extending in the direction of a longitudinal axis of the die rod between a die base and the second end is formed in the die rod, and wherein a reflective surface facing the non-contact distance measuring device is arranged at the die base for a measurement signal emitted by the non-contact distance measuring device through the die rod, and the non-contact distance measuring device comprises a sensor arranged relative to the reflective surface for the non-contact detection of the measurement signal reflected from the reflective surface to the sensor.

According to a second aspect of the invention, a capillary rheometer is provided which is equipped with at least one such test chamber assembly.

One of the ideas underlying the present invention is to measure the strains in the die tip and the test chamber, so that these can be mathematically compensated for in the measurement data obtained for the test mass. This facilitates the determination of the position of the die tip under pressure and temperature conditions that differ from the initial conditions. In this way, the relative change in position of the contact point between the die and the test mass can be recorded without the influence of the transmission element, i.e. the displacement device or the surrounding test chamber, such as compression of the die material due to pressure, geometric influences due to, for example, bending, or changes in length due to temperature gradients, etc. The non-contact distance measuring device for detecting the position of the die tip is arranged outside the test chamber and is therefore not influenced by the temperature conditions there. The invention enables strain compensation through the structural arrangement of a distance measuring device decoupled from the displacement device, which measures through the die rod, whereby the temperature-or pressure-induced positional change of the die base due to strain in the die tip or the die base is detected by evaluating a measurement signal emitted in the direction of the die base and reflected from there to the sensor. Based on the modulation of the reflected signal, a strain-based positional change of the die tip or the die base can be determined and quantified. The modulation of the reflected signal caused by the elongation of the stamp tip due to temperature and pressure conditions can be converted into a displacement signal representing a change in distance between the stamp tip and the distance measuring device, and the actual elongation of the stamp tip can be determined metrologically. The recorded expansion can then be combined with the information from a displacement measurement system of the displacement device, thereby increasing the overall measurement accuracy of the capillary rheometer. The method of length compensation by measurement offers advantages over computational compensation. With length compensation by measurement, changes in length are recorded directly and in real time, regardless of whether the strain is thermally or mechanically induced. A further advantage is that measurements are independent of geometric changes to the design or the choice of material; consequently, no calculation parameters need to be adjusted in the event of changes to the instrument or component configuration of the capillary rheometer equipped with the test chamber assembly according to the invention. Naturally, two or more test chamber assemblies of the same construction and function as described in the invention may also be arranged in a measuring instrument, in particular a capillary rheometer, in order to carry out simultaneous measurements and/or to increase the sample throughput of the instrument.

Advantageous embodiments and developments can be found in the dependent claims relating to the independent claims and in the description with reference to the figures.

According to one embodiment of the test chamber assembly, the sensor has a measurement resolution of between 0.001 mm and 0.008 mm, preferably 0.005 mm. The sensor's high measurement resolution of 0.001 mm to 0.008 mm, preferably 0.005 mm, enables the detailed detection of even the smallest expansions and strains in the measuring body. This has the advantage that the position of the die tip relative to the die base can be precisely determined in the event of expansions caused by pressure, temperature or mechanical influences, and reliably compensated for when evaluating the measurement results, thereby achieving greater measurement accuracy in rheological measurements. The precise detection and compensation of strain is particularly important in high-pressure and high-temperature environments in capillary rheometers. The test chamber assembly according to the invention thus increases overall measurement accuracy in a structurally simple manner and improves the reproducibility of the measurements.

According to a development, in the test chamber assembly of the invention, the sensor is configured as a laser distance sensor, radar distance sensor, microwave distance sensor, LiDAR distance sensor, ultrasonic distance sensor or a combination thereof. The aforementioned non-contact distance sensors, such as laser, radar, LiDAR and ultrasonic distance sensors, measure the strain-induced change in distance between the die base and the sensor using a time-of-flight or phase-shift principle. The change in distance is determined by detecting the reflection of the transmitted signal at the reflective surface on the die base. In this process, the sensor emits a signal (light/laser, radar/microwave or ultrasonic signal) which travels at a constant speed and is reflected back to the sensor by the reflective surface on the die base. The sensor measures the transit time of the emitted and reflected signal between the die base and the sensor. The distance to the reflective surface is calculated from the transit time and the known propagation speed of the signal. A change in the distance between the sensor and the base of the die, and thus the die tip, due to temperature-or pressure-induced expansion during the rheological measurement leads to a change in the transit time, which the sensor detects and converts into a change in distance. The die base or a reflective means positioned there serves as the reflective surface for the signal. Alternatively, the change in distance can be measured by the phase shift of the transmitted sensor signal. In this case, the sensor transmits a continuous signal at a defined frequency. The reflected signal is reflected back to the sensor with a phase shift. A value for the change in distance between the die base and the sensor can be derived from the phase shift of the reflected signal. An elongation of the die tip and thus of the die base changes the phase shift in proportion to the change in distance, which is precisely detected by the sensor and can then be used for strain compensation in the evaluation of the rheological measurement. According to the invention, the distance measuring device, equipped with the respective distance sensor or sensors, is arranged centrally in the region of the open bore in the die rod, which extends in the direction of the longitudinal axis of the die rod between the distance measuring device and the die base, but is decoupled from it. The sensor signal is transmitted through the die rod towards the die base and is reflected back to the sensor through the bore by the die base located at the end of the die rod, or by the reflective surface or reflective medium provided there. Ultrasonic sensors could also be used, as they can utilise the closed end of the tube as a reflector. The sensor measures the transit time of the sound to calculate the change in distance.

The distance-measuring device in the test chamber assembly of the invention advantageously enables non-contact and extremely precise detection of changes in the distance between the sensor and the die tip. The sensors described are also characterised by a fast response time during dynamic processes, such as in rheological measurements. This allows rapid changes in distance caused by pressure-or temperature-induced expansion of the die or the die tip to be detected without delay, thereby improving the real-time analysis of the material properties of the test mass. The immediate signal processing by the sensor simplifies the electronic evaluation and further processing of the measurement data. Thus, the detected changes in distance can be directly incorporated into the data analysis for strain compensation.

According to a further embodiment, at least a portion of the surface of the stamp base facing the sensor is formed as a reflective surface. The reflective surface may preferably be designed as a mirror or prism or may have a surface texture. If, in addition or alternatively, a separate reflective means connected to the die base is used, this is preferably designed as a mirror or prism or has a surface texture. The design of the reflective surface is advantageously tailored to the selected sensor or the measurement method that can be carried out with it. The use of a separate reflective means allows the stamp or stamp base to be equipped without the need for direct modifications to the stamp base, such as high-precision machining or texturing of the base surface, thereby simplifying manufacture.

If the reflective surface or the separate reflective means, as provided for in a preferred embodiment, is designed as a prism mounted on the die base, this advantageously allows the transverse expansion of the die base to be detected in addition to the longitudinal expansion. To measure longitudinal elongation, the prism is designed or arranged such that the signal emitted by the sensor is reflected directly back to the sensor, so that the change in distance is measured by means of a time-of-flight measurement as described. To measure transverse expansion, the prism is designed or positioned such that the signal is deflected laterally and strikes the inner circumferential wall of the die base or the die tip. The beam is reflected from the circumferential wall back to the sensor. By analysing the lateral reflections, the sensor can additionally capture information regarding changes in the transverse expansion of the die tip due to the effects of temperature and pressure, and the derived values can be incorporated into the computational strain compensation. For this purpose, the prism can, for example, be designed as an angle prism or a retroreflector, which allows both direct back reflection and lateral deflection. When using a prism, the sensor must be adapted accordingly to evaluate the different reflection signals.

According to a development, the reflective surface or the reflective medium has the same coefficient of thermal expansion as the stamp tip. Since the reflective surface or reflective medium undergoes the same expansion as the die tip or die base when the temperature changes, the position of the die tip or die base can be precisely detected in the distance measurement. This allows positional changes attributable to thermal expansion to be reliably detected, mathematically compensated for, and the measurement accuracy of devices equipped with the test chamber assembly according to the invention to be improved in a simple manner. In applications such as capillary rheometry, where high temperatures frequently occur, the reflective surface or reflective medium remains dimensionally stable due to its coefficient of thermal expansion being identical to that of the stylus tip. This increases the reliability of the position measurement even under highly fluctuating or high temperatures.

According to a further embodiment of the test chamber assembly of the invention, the displacement device comprises a spindle drive. A spindle drive allows for precise control and measurement of the travel distance and positioning of the die tip. This is advantageous for the precise travel measurement of the displacement device, as the spindle drive enables uniform movement and thus improves the accuracy of position determination throughout the entire system. Spindle drives also offer high reproducibility, as the positioning remains stable regardless of load influences and therefore enables the precise positioning of the die tip even under varying loads. The continuous and uniform movement of a spindle drive allows for reliable integration into displacement measurement systems, such as linear potentiometers, optical or inductive measurement systems. This allows for precise and continuous measurements of the displacement position, which, in conjunction with the test chamber assembly according to the invention, further improves measurement accuracy. As non-limiting alternative drives for the displacement device, hydraulic drives, linear motors and piezo motors, for example, may also be considered.

According to a further embodiment of the test chamber assembly of the invention, a further non-contact distance measuring device is provided, arranged outside the test chamber and below the test chamber floor, for the non-contact detection of the test chamber's dimensions, wherein the test chamber floor is associated with a further reflective surface or a further reflective means facing the further non-contact distance measuring device for a measurement signal emitted by the further non-contact distance measuring device, and the non-contact distance measuring device comprises a further sensor arranged opposite the further reflective surface or the further reflective means for the non-contact detection of a measurement signal reflected from the further reflective surface or the further reflective means to the further sensor. Since not only the die tip but also the test chamber and its base expand in response to changes in temperature and pressure, the additional distance-measuring device enables precise detection of the expansion of the test chamber base and/or an extrusion die or its die base, which is used therein in a beneficial development of the test chamber assembly or the capillary rheometer equipped therewith. This information can be mathematically combined with the expansion of the die tip, so that the total expansion of the system is effectively compensated for and an extremely precise detection of the contact point between the die and the test material is achieved. The non-contact measurement of the test chamber expansion below the test chamber base advantageously ensures that the distance measuring device itself is not influenced by the temperature and pressure within the test chamber. The additional sensor thus provides measurement data that enables precise compensation for the thermal expansions of the test chamber. The spatial separation of the distance measurement devices for the die tip and the test chamber floor allows independent detection of the respective expansions. This reduces measurement errors that could arise from direct or mechanical interference and enables a precise breakdown of the expansion effects, which can then be incorporated separately or combined into the calculation or mathematical correction of the measurement results. As the distance measuring device continuously records the expansion of the test chamber base or the nozzle base of the extrusion die inserted therein, thermal expansion can be recorded dynamically and in real time during rheometer operation and compensated for mathematically. This is particularly advantageous when the temperatures or pressures inside the test chamber change during a test cycle, ensuring that the precise position of the test chamber base or the nozzle base of the extrusion nozzle inserted therein, or their pressure-or temperature-dependent expansion, can be determined at any time.

According to a development, the sensor has a measurement resolution of between 0.001 mm and 0.008 mm, preferably 0.005 mm. Advantageously, the high measurement resolution of the sensor allows even the smallest changes in distance caused by the expansion of the test chamber or the test chamber floor to be detected, thereby significantly increasing the accuracy of the detection and compensation of thermal and mechanical expansions. The high resolution of the sensor also enables a differentiated measurement of strains independent of external influences. This leads to an accurate determination of the actual positional changes of the test chamber base, which contributes to the dynamic compensation of the total strain and thus increases measurement accuracy during rheometer operation.

In accordance with a further embodiment, the additional sensor is configured as a laser distance sensor, radar sensor, microwave sensor, LiDAR sensor, ultrasonic sensor or a combination thereof. The additional sensor advantageously enables contactless, precise measurement of the distance or change in distance between the reflective surface or reflective material on the test chamber floor or nozzle base and the sensor. This allows the expansion of the test chamber floor or nozzle base to be accurately recorded without mechanical stress, thereby improving the accuracy of thermal expansion compensation. The measurement allows changes in position or distance at the test chamber base or the nozzle base to be detected immediately and without delay in a contactless manner and enables dynamic compensation of the total expansion during rheometer operation. With regard to the design and advantages of the respective sensors, reference is made in full to the above descriptions to avoid repetition.

According to a further embodiment, at least a partial area of a surface of the test chamber base and/or the nozzle base facing the further sensor is formed as a further reflective surface, wherein the further reflective surface may be formed as a mirror or prism or may have a surface texture.

According to a development, the additional reflective surface is provided on a further reflective means connected to the test chamber base and/or the nozzle base, and the reflective means is preferably designed as a mirror or prism and/or the additional reflective means has a surface texture.

With regard to the advantages and embodiments of the aforementioned developments, to avoid repetition, full reference is made to the descriptions relating to the distance measuring device described previously, which apply in the same manner to the further distance measuring device.

According to a further embodiment, the additional reflective surface or the additional reflective means has the same coefficient of thermal expansion as that of the test chamber base or the nozzle base. Since the further reflective surface or the further reflective means undergoes the same expansion as the test chamber base or the nozzle base when the temperature changes, the position of the test chamber base or the nozzle base can be detected more precisely in the distance measurement. This allows positional changes attributable to thermal expansion to be reliably detected and mathematically compensated for, thereby improving the measurement accuracy of devices equipped with the test chamber assembly according to the invention in a simple manner. In applications such as capillary rheometry, where high temperatures frequently occur, the additional reflective surface or reflective medium remains dimensionally stable due to its coefficient of thermal expansion being identical to that of the test chamber base or nozzle base. This increases the reliability of the position measurement even under highly fluctuating or high temperatures.

In accordance with a development, a receptacle is provided for the positionally fixed attachment of the additional non-contact distance measuring device to the test chamber or the test chamber base. To ensure the positionally fixed attachment of the receptacle, a force-fit connection between the receptacle and the test chamber base, or at least a clamping means, preferably a compression spring, is provided. To form a force-fit connection, the receptacle can be screwed, snapped into place or connected by means of a plug-in connection to the test chamber floor or the test chamber, whereby corresponding connecting means, for example screw threads, snap-fit or plug-in receptacles, are provided in the receptacle and on the test chamber floor. In the case of an alternative or additional connection via a clamping means, the receptacle preferably comprises at least one clamping means, in particular a compression spring, for positionally fixed securing of the receptacle. Without limiting the invention thereto, alternative clamping means are of course available for the positionally fixed securing of the receptacle to the test chamber base, which may be used alternatively or in addition in connection with the present invention. For example, the fixing may be achieved via an elastomer or rubber element, clamping or tensioning screws, by means of magnetic fixing, by means of clamping rings or bushings, or by means of a form-fitting holder (e.g. by means of dowel pins). The selection of suitable clamping means can be adapted depending on the specific conditions and requirements of the respective device incorporating the test chamber assembly according to the invention. It is also possible to use different clamping means in combination with one another. The positionally fixed receptacle of the additional non-contact distance measuring device to the test chamber floor offers the advantage that the additional non-contact distance measuring device remains in a fixed position even under thermal or mechanical loads, thereby enabling consistent and accurate measurement of the expansion of the test chamber.

According to a further embodiment, the receptacle has a tubular extension of the test chamber base. This ensures stable and precise transmission of the sensor signal between the additional sensor and the additional reflective surface or the additional reflective means, and the reliable measurement of the test chamber dimensions. The design of the holder as a tubular extension also allows excess material, particularly during pVT measurements, to be drained from the test chamber via the holder.

In accordance with a development of the capillary rheometer, the test chamber base is designed to be closed or fitted with a sealable extrusion die. This has the advantage of increasing flexibility for different application requirements whilst the test chamber design remains otherwise identical. A closed test chamber base allows for precise pressure and temperature measurements within the test chamber, whilst the extrusion nozzle enables the controlled discharge of excess test material to adjust the measurement volume during pVT measurements.

Naturally, embodiments of the capillary rheometer with test chamber assemblies according to the invention, which feature distance measuring devices arranged only in the region of the die rod or the die, or only in the region of the test chamber base, are also covered by the invention.

The above embodiments and developments may, where appropriate, be combined with one another as desired. Further possible embodiments, modifications and implementations of the invention also include combinations of features of the invention described previously or below in relation to the examples of embodiment, which are not explicitly mentioned. In particular, the person skilled in the art will also add individual aspects as improvements or additions to the respective basic form of the present invention.

### BRIEF DESCRIPTION OF THE DRAWINGS

The present invention is explained in more detail below by means of exemplary embodiments with reference to the accompanying figures of the drawings. In the figures:

FIG. 1a shows a schematic representation of a capillary rheometer according to an embodiment of the invention in a side view;

FIG. 1b shows a schematic representation of the capillary rheometer of the embodiment shown in FIG. 1a in cross-section;

FIG. 2 shows a schematic representation of a section of the test chamber assembly according to a further embodiment of the invention, shown in cross-section;

FIG. 3 shows a schematic detailed view of a section of the test chamber assembly according to an embodiment of the invention, shown in cross-section;

FIG. 4 shows a schematic detailed view of a section of the test chamber assembly according to an embodiment of the invention, shown in cross-section;

FIG. 5 shows a schematic detailed view of a section of the test chamber assembly according to an embodiment of the invention, shown in cross-section; and

FIG. 6 shows a schematic representation of a capillary rheometer according to a further embodiment of the invention, shown in cross-section.

### DETAILED DESCRIPTION

In the figures of the drawings, identical, functionally equivalent and similarly acting elements, features and components are, unless otherwise stated, each designated by the same reference signs.

Although specific embodiments and modifications are illustrated and described herein, it will be apparent to those skilled in the art that a variety of alternative and/or similar embodiments may replace the specific embodiments illustrated and described without departing from the scope of the present invention. This application is intended to cover, in general, all variations or modifications of the specific embodiments described herein.

The accompanying figures are intended to provide a further understanding of embodiments of the invention and serve, in conjunction with the description, to explain the principles and concepts of the invention. Other embodiments and many of the advantages mentioned are apparent from the drawings. The drawings are to be understood merely as schematic drawings, and the elements of the drawings are not necessarily shown to scale in relation to one another. Directional terminology such as ‘top’, ‘bottom’, ‘left’, ‘right’, ‘above’, ‘below’, ‘horizontal’, ‘vertical’, ‘front’, ‘rear’ and similar indications are used solely for explanatory purposes and do not serve to limit the generality to specific embodiments as shown in the figures.

Dotted lines in the figures of the drawings indicate that the connections between the components linked by the dotted lines do not necessarily have to be in physical contact with one another but may equally be coupled wirelessly to one another.

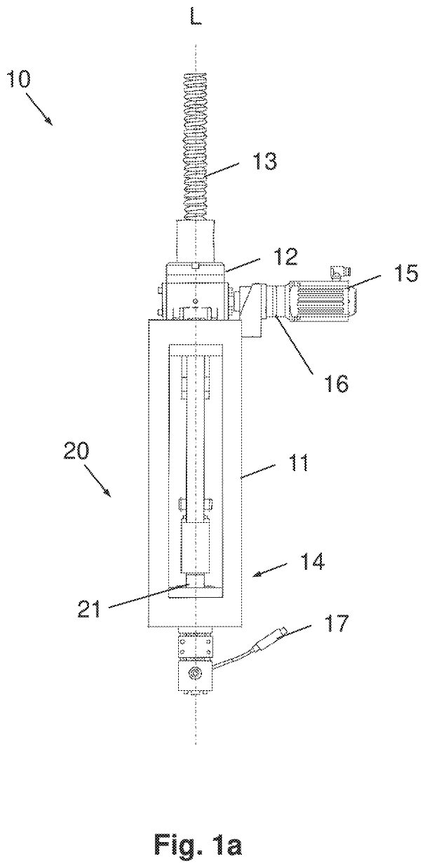

FIG. 1a shows a side view schematic representation of a part of a capillary rheometer 10 according to an exemplary embodiment of the invention, which contains the test chamber assembly 20 of the invention. Shown schematically is a central housing 11 in which the main components of the capillary rheometer 10 are housed. The device shown comprises a displacement device 12 which, by means of a spindle drive 13, moves a die 14, concealed in FIG. 1a, linearly along the longitudinal axis L of the device. A motor 15 is mounted on the side of the device and is connected to the spindle drive 13 via a shaft 16 to perform the linear movement. At the lower end of the housing 11 is the test chamber assembly 20 of the invention, with a pressure sensor 17 arranged at the side for measuring the rheological properties of the test material introduced into the test chamber 21 and subjected to pressure via the die 14. The test chamber 21 is designed to be heated.

FIG. 1b shows a schematic cross-sectional view of the part of the capillary rheometer 10 according to the embodiment shown in FIG. 1a. The figure shows the test chamber assembly 20 and its structure in detail. The test chamber assembly 20 comprises a test chamber 21, which can be fixed within the device and extends in the direction of the longitudinal axis L. The test chamber 21 is filled with a test material to be examined, which is liquefied by heating the test chamber 21. A die 14 is inserted into the test chamber 21 during the measurement. The die 14 has a die tip 18 which rests on the test material and applies pressure to it as soon as the displacement device 12, driven by the spindle drive 13, is moved linearly along the longitudinal axis L within the apparatus. The die 14 comprises a die rod 19 which extends the die tip 18 in the direction of the displacement device 12, which may also be referred to as a die carriage.

In the exemplary embodiment, the die rod 19 is provided with a central bore 22 which extends from the upper end 23 of the die rod 19, which is secured in the sliding mechanism 12, to the die tip 18. However, the bore 22 does not penetrate the die base 24 but terminates at the die tip 18. The distance measuring device 30a, which is decoupled from the upper end 23 of the die rod 19, is arranged in the displacement device 12. The distance measuring device 30a transmits a sensor signal into the bore 22 and comprises a sensor 31a which is configured to detect the measurement signal MS, represented by an arrow, reflected from a reflective surface 33a on the die base 24, represented by an arrow, and to detect the distance or a change in distance between the sensor 31a and the reflective surface 33a in the event of pressure-or temperature-induced expansion of the die tip 18 or the die base 24, and to derive a measured value for the change in distance. The reflective surface 33a is arranged directly on the stamp base 24 and has the same area as the stamp base 24. From the measured values recorded by the sensor 31a, any expansion of the stamp 14 or the stamp base 24 during the rheological measurement, which occurs when the stamp 14 is subjected to temperature and pressure, can be detected without contact. The measured values recorded in this way can be used for strain compensation in the evaluation of the rheological measurement in order to correct the measurement results mathematically.

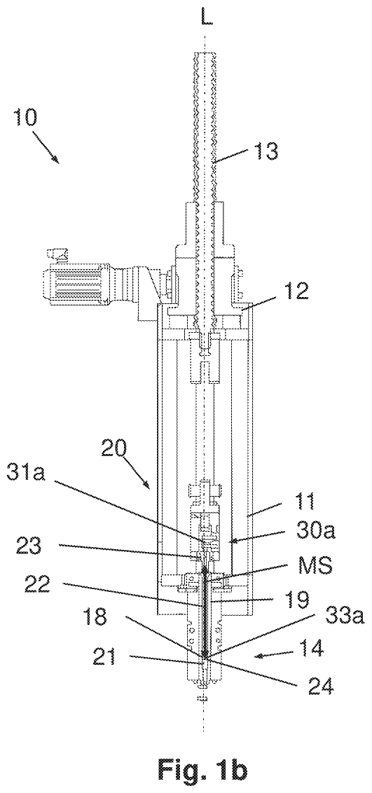

FIG. 2 shows a schematic cross-sectional view of a detail of the test chamber assembly 20 according to a further embodiment of the invention. In the embodiment shown in FIG. 2, a distance measuring device 30a is arranged on the die 14 and a further distance measuring device 30b is arranged on the test chamber base 25 to detect temperature—and pressure—induced expansion, on the one hand, of the die 14 or the die tip 18 and/or the die base 24 and, on the other hand, of the test chamber base 25. The extrusion nozzle 36 inserted into the test chamber base 25 is used during a pVT measurement to discharge material from the test chamber 21 in order to set the sample volume required for the measurement. During the actual measurement, the extrusion nozzle 36 and thus the test chamber 21 are sealed tightly by an inserted sealing screw 37. In the embodiment, both distance measuring devices 30a are equipped with non-contact measuring sensors 31a, b, such as a laser distance sensor, radar sensor, microwave sensor, LiDAR sensor, ultrasonic sensor or combinations thereof, which are arranged decoupled from the die 14 or the test chamber base 25. The sensors 31a, b detect a change in position of reflective surfaces 33a, b provided in the die 14 or die base 24 or on the test chamber base 25. The reflective surface 33b provided on the test chamber base 25 surrounds the extrusion die 36 or its die base 35 in an annular manner.

The distance-measuring device 30a associated with the die 14 is integrated into the displacement device 12, whilst the further distance measuring device 30b is fixed to the outer surface of the test chamber base 25 via a receptacle 34 which supports the distance measuring device 30b and, in the exemplary embodiment shown, is screwed to the test chamber base 25. The measurement takes place in an annular gap 38 formed between the tubular receptacle 34, which extends the test chamber base 25, and the inner circumferential wall 39 of the receptacle 34; this gap serves to guide the transmitted and reflected measurement signal MS to the additional sensor 31b. The annular gap 38 is closed off on the test chamber side by the test chamber base 25, which provides or supports the annular reflection surface 33b. The housing 34 also serves to fix the additional distance measuring device 30b in a fixed position on the test chamber base 25.

The upper end 23 of the die rod 19, which extends the die 14, is secured in a pressure piece 26 integrated into the sliding assembly 12, which can be preloaded via clamping screws 27. In order to detect the change in length of the die 14 resulting from thermal expansion and compression due to compressive force, the die rod 19 is drilled through along its longitudinal axis L. Into this bore 22, the sensor 31a emits a measurement signal MS directed towards the die base 24, which, after reflection at the reflective surface 33a in the die base 24, is returned via the bore 22 to the sensor 31a and detected there. In doing so, the sensor 31a emits a measurement signal MS, depending on the sensor configuration, for example a light/laser, radar/microwave or ultrasonic signal, which travels at a constant speed and is reflected back to the sensor 31a by the reflective surface 33a in the surface 32a of the die base 24. The sensor 31a measures the transit time of the transmitted and reflected measurement signal MS between the stamp base 24 and the sensor 31a. The distance to the reflective surface 33a is calculated from the transit time and the known propagation speed of the measurement signal MS. A change in the distance between the sensor 31a and the stamp base 24, and thus the stamp tip 18, due to temperature-or pressure-induced expansion during the rheological measurement, leads to a change in the transit time, which the sensor 31a detects and converts into a change in distance.

In the exemplary embodiment, the die tip 18 is screwed to the die rod 19, although a plug-in or snap-fit connection is also possible. Above the upper end 23 is the sensor 31a, which in the embodiment is mounted in the distance measuring device 30a in a height-adjustable manner. In the embodiment, the sensor 31a is of a high-precision design with a measuring resolution of 0.005 mm. If the position of the die tip 18 or the die base 24 changes, this change in position relative to the position of the displacement device 12, also referred to as the die slide, is detected and can be compensated for.

In a similar manner, the deflections of the test chamber 21, also referred to as the barrel, and of the test chamber base 25 are also recorded in order to determine the position of the test chamber base 25 and of the nozzle base 35 of an extrusion nozzle 36 located in the test chamber base 25, which may also be referred to as a pVT nozzle. The additional distance measuring device 30b on the test chamber base 25 is equipped with a further sensor 31b, which performs distance or distance change measurements according to the same measuring principle as described above. A further, annular reflective surface 33b is provided for this purpose on the surface 32b of the test chamber base 25 facing the sensor 31b.

On the basis of the measured values recorded by the two distance measuring devices 30a, b and their respective displacement measuring systems, the distance between the die tip 18 on the one hand and the test chamber base 25 or the nozzle base 35 on the other hand can be precisely determined.

Naturally, embodiments of the capillary rheometer 10 with a test chamber assembly 20 according to the invention are also possible which comprise only the distance measuring device 30a, b arranged in the region of the die rod 19 or the die 14, or only that arranged in the region of the test chamber base 25.

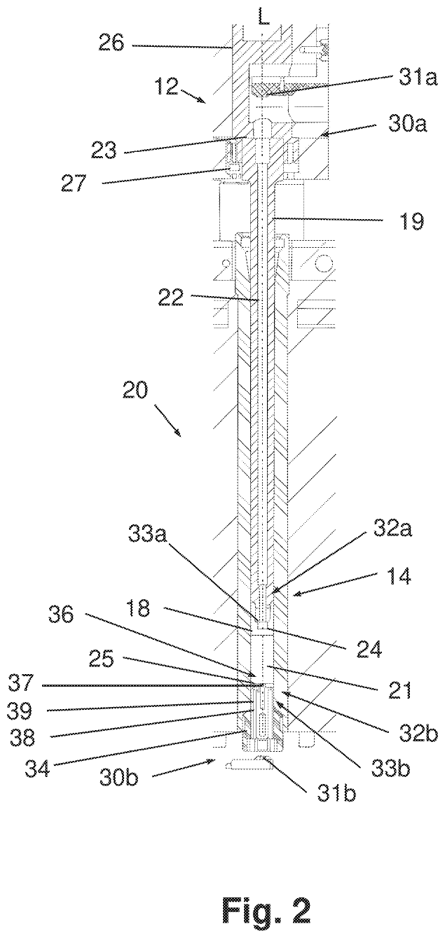

FIG. 3 shows a schematic representation of the die base 24 with the reflective surface 33a arranged within it, which is inserted into the die base 24. The reflective surface 33a is positioned below a central bore 22 in the die rod 19 and has the same coefficient of thermal expansion as the surrounding die base 24 and the entire die tip 18. Since the reflective surface 33a expands to the same extent as the die tip 18 in response to temperature changes, a change in distance between the sensor 31a and the reflective surface 33a, detected by the sensor 31a in the distance measuring device 30a, corresponds to the expansion of the die tip 18 or the die base 24 due to the effects of pressure or temperature during the rheological testing process.

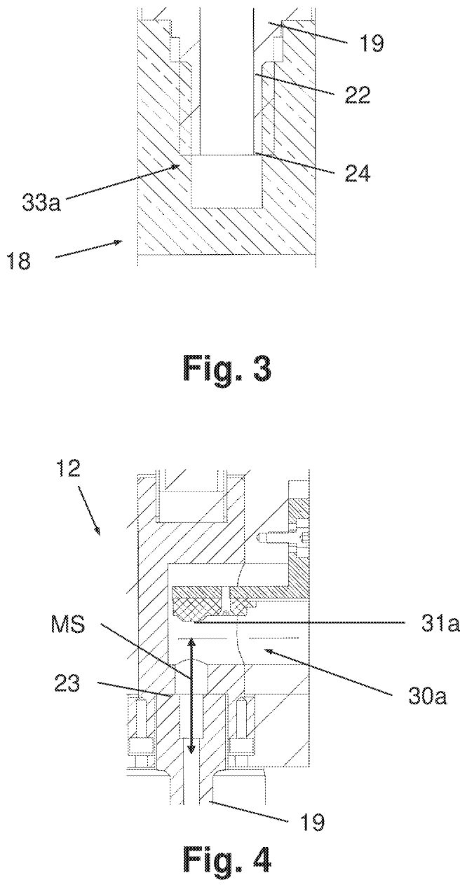

FIG. 4 shows a detailed sectional view of the upper end 23 of the die rod 19, the distance measuring device 30a and a portion of the displacement device 12 of a capillary rheometer 10 according to an exemplary embodiment of the invention. At the upper end 23 of the die rod 19, the distance measuring device 30a is provided to detect the change in distance between the reflective surface 33a provided at the lower end of the bore 22 in the die 14 or the die rod 19 and the sensor 31a. The measured values are used for strain compensation when evaluating the rheological test results.

The distance measuring device 30a is equipped with a sensor 31a which, when a measurement is being carried out, emits a measurement signal MS into the bore 22, directed towards the reflective surface 33a. The measurement signal is reflected by the reflective surface and detected by the sensor 31a. The sensor 31a measures the transit time of the transmitted and reflected measurement signal MS between the die base 24 and the sensor 31a. The distance between the sensor 31a and the reflective surface 33a is calculated from the transit time and the known propagation speed of the measurement signal MS, thereby enabling a change in distance to be measured when the die tip 18 is extended. The distance measuring device 30a and the sensor 31a are arranged in a height-adjustable manner in the sliding assembly 12 above the upper end 23 of the die rod, but are decoupled from the die rod 19. This allows the smallest positional changes of the die 18 due to thermal expansion or mechanical stresses to be measured and subsequently compensated for by calculation, for example when determining the volume between a nozzle, such as an extrusion nozzle 36, and the die tip 18.

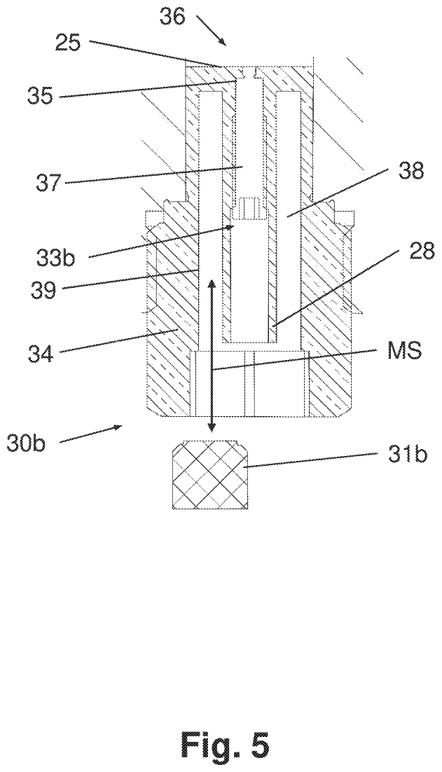

FIG. 5 shows a schematic representation of the further distance measuring device 30b on the test chamber base 25, according to a further embodiment of the invention. The further distance measuring device 30b, or rather the further sensor 31b provided therein, is arranged in the embodiment at the end of a receptacle 34 having a tubular extension 28. This extends between the further distance measuring device 30b and the test chamber floor 25. Between the tubular extension 28 and the inner circumferential wall 39 of the housing 34, an annular gap 38 is formed, extending over the length of the tubular extension 28 to the test chamber floor 25, into which the measurement signal MS is emitted and from which it is reflected by the annular further reflective surface 33b surrounding the tubular extension 28 at the test chamber floor 25 to the further sensor 31b. The annular gap 38 serves to guide the measurement signal MS emitted by the further sensor 31b.

In the exemplary embodiment shown in FIG. 5, the extrusion die 36 is sealed by means of a sealing screw 37. To carry out pVT measurements, the sealing screw 37 is removed in order to drain material from the test chamber 21 to set the measurement volume required for the measurement. Once the measurement volume has been set, the sealing screw 37 is reinserted to completely seal the test chamber 21. In the embodiment, the additional, annularly shaped reflective surface 33b is also located on the test chamber base 25, thereby enabling measurement of the expansion of the test chamber base 25 as close as possible to the sample or test chamber. The additional sensor 31b is arranged decoupled from the mount 34 and can thus detect changes in distance between the sensor 31b and the test chamber base 25 without itself being subject to any pressure-or temperature-induced positional changes. The strain compensation at the test chamber base 25 operates on the same functional principle as at the die rod 19, even though the design differs. The receptacle 34, which features the tubular extension 28, also serves to drain excess material from the test chamber 21 during pVT measurements, with the tubular extension 28 protecting the reflective surface 33b from contamination by the sample material. The holder 34 can be screwed into place, for example to the test chamber base 25 or the test chamber 21, to fix its position.

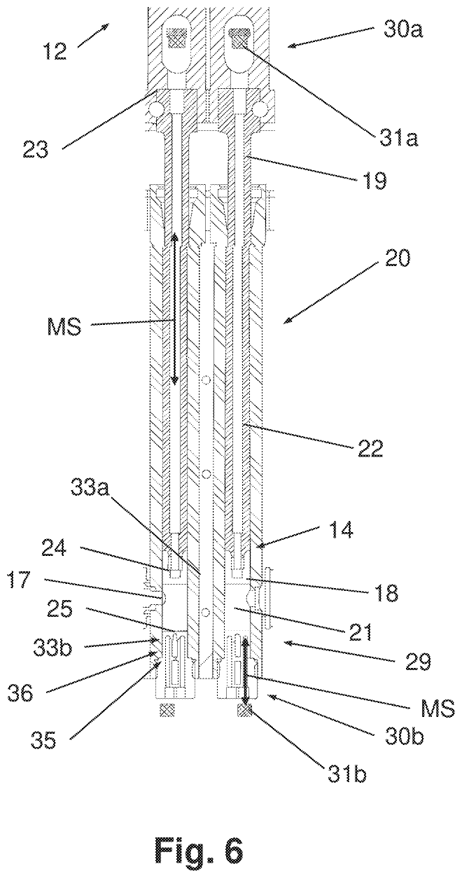

FIG. 6 shows a schematic cross-sectional view of the test chamber assembly in a capillary rheometer 10 according to a further embodiment of the invention. In this exemplary embodiment, two test chamber assemblies 20 are provided, arranged side by side. The invention is not limited to this. Naturally, more than two of the test chamber assemblies 20 according to the invention may also be arranged in a single device, for example to increase the sample throughput of the device.

The configuration shown allows for simultaneous measurements in both test chambers 21 and the recording of strains in the test chamber assemblies 20 for strain compensation in the results of the test runs. Both test chamber assemblies 20 are of identical construction and each have a die rod 19 that protrudes into the test chamber 21 and is moved from above via a common displacement device 12 with a single central spindle drive 13 (see FIG. 1). The displacement device 12 controls the pressure exerted on the test mass. The configuration with two test chambers 21 makes it possible to test different samples in parallel or to carry out several series of measurements under identical conditions, thereby improving the comparability of the results.

Each test chamber 21 features a distance measuring device 30a, b as described previously, both at the upper end 23 of the die rod 19 and at the test chamber base 25 or the nozzle base 35 of an extrusion nozzle 36 provided there, for detecting temperature-or pressure-induced strains in the test chambers 21. Visible are both the die rods 19 featuring the bore 22 and the arrangement of the distance measuring devices 30a, b with their respective sensors 31a, b.

Die rods 19 are inserted into each test chamber 21; these are driven by the common displacement device 12, which moves the dies 14 in order to apply controlled pressure via the die tips 18 to the test masses melted in the respective test chambers 21 following the heating of the test chambers 21. Each die rod 19 is associated with a distance measuring device 30a for contactless detection of the distance between the sensors 31a and the die tip 18 or the die base 24.

At the lower end 29 of each test chamber 21, further distance-measuring devices 30b are mounted to detect the thermal and pressure-induced expansion of the test chamber bases 25 and the nozzle bases 35 of the extrusion nozzles 36 arranged therein. The additional distance measuring devices 30b also comprise decoupled sensors 31b. The sensors 31b measure, on the basis of the transit times of the measurement signals MS, the change in position of the reflective surfaces 33b caused by the expansion of the test chamber bases 25 and/or the nozzle base 35. The recorded values are used for strain compensation when evaluating the results of the rheological material tests in the test chambers 21. Pressure sensors 17 are arranged laterally at the lower ends of the test chamber assemblies 20 to measure the rheological properties of the test materials introduced into the test chambers 21 and pressurised via the die 14.

Naturally, embodiments of the capillary rheometer 10 with the test chamber assemblies 20 according to the invention are also possible which comprise only the distance measuring devices 30a, b arranged in the region of the die rod 19 or the die 14, or only those arranged in the region of the test chamber base 25.

In the preceding detailed description, various features have been summarised in one or more examples to improve the clarity of the presentation. It should be clear, however, that the above description is merely illustrative and in no way limiting. It serves to cover all alternatives, modifications and equivalents of the various features and exemplary embodiments. Many other examples will be immediately and readily apparent to the person skilled in the art in view of the above description.

The exemplary embodiments have been selected and described in order to best illustrate the principles underlying the invention and their potential applications in practical use. This enables those skilled in the art to optimally modify and utilise the invention and its various embodiments in relation to the intended purpose. In the claims and the description, the terms ‘including’ and ‘having’ are used as neutral terms for the corresponding term ‘comprising’. Furthermore, the use of the terms ‘a’, ‘an’ and ‘one’ should not, as a matter of principle, exclude a plurality of features and components described in this manner.

1. A test chamber assembly, in particular in a capillary rheometer, comprising:
a test chamber which can be filled with a test mass and is heatable, including a test chamber base;
a die arranged in the test chamber so as to be linearly displaceable, including a die rod and a die tip connected to a first end of the die rod, which applies pressure to the test material and has a die base;
a displacement device receiving a second end of the die rod for displacing the die within the test chamber in the direction of the test chamber base; and
a non-contact distance measuring device arranged in the displacement device, decoupled from the die and movable with the displacement device, for detecting die elongation,
wherein a bore extending in the direction of a longitudinal axis of the die rod between the die base and the second end is formed in the die rod, and wherein a reflective surface facing the non-contact distance measuring device for a measurement signal emitted by the non-contact distance measuring device through the die rod, and the non-contact distance measuring device includes a sensor arranged relative to the reflection surface for the contactless detection of the measurement signal reflected from the reflective surface to the sensor.

2. The test chamber assembly according to claim 1, wherein the sensor has a measurement resolution of between 0.001 mm and 0.008 mm.

3. The test chamber assembly according to claim 1, wherein the sensor is designed as a laser distance sensor, radar sensor, microwave sensor, LiDAR sensor, ultrasonic sensor or a combination thereof.

4. The test chamber assembly according to claim 1, wherein at least a portion of the surface of the die base facing the sensor of the die base facing the sensor is configured as a reflective surface, wherein the reflective surface is configured as a mirror or prism or has a surface texture.

5. The test chamber assembly according to claim 1, wherein the reflective surface is provided on a reflective means connectable to the die base and the reflective means is formed as a mirror or prism and/or has a surface texture.

6. The test chamber assembly according to claim 1, wherein the reflective surface or the reflective means has the same coefficient of thermal expansion as the die tip and/or the die base.

7. The test chamber assembly according to claim 1, wherein the displacement device comprises a spindle drive.

8. The test chamber assembly according to claim 1, wherein a further non-contact distance measuring device is arranged outside the test chamber below the test chamber base for non-contact detection of a test chamber dimension, wherein the test chamber base is associated with a further reflective surface or a further reflective means facing one of the further non-contact distance measuring devices for a measurement signal emitted by the further non-contact distance measuring device, and the non-contact distance measuring device comprises a further sensor arranged relative to the further reflective surface for the non-contact detection of a measurement signal reflected by the further reflective surface or the further reflective means towards the further sensor.

9. The test chamber assembly according to claim 8, wherein an extrusion die arranged in the test chamber base is provided with a die base and the further reflective surface or a reflective means is provided on or in the die base.

10. The test chamber assembly according to claim 8, wherein the sensor has a measurement resolution of between 0.001 mm and 0.008 mm.

11. The test chamber assembly according to claim 8, wherein the further sensor is designed as a laser distance sensor, radar sensor, microwave sensor, LiDAR sensor, ultrasonic sensor or a combination thereof.

12. The test chamber assembly according to claim 8, wherein at least a partial area of a surface facing the further sensor of the test chamber floor and/or the nozzle base facing the further sensor is configured as a further reflective surface, wherein the further reflective surface is configured as a mirror or prism or has a surface texture.

13. The test chamber assembly according to claim 8, wherein the further reflective surface is provided on a further reflective means connectable to the test chamber base and/or the nozzle base, and the further reflective means is formed as a mirror or prism and/or has a surface texture.

14. The test chamber assembly according to claim 8, wherein the further reflective surface or the further reflective means has the same coefficient of thermal expansion as the test chamber base and/or the nozzle base.

15. The test chamber assembly according claim 8, wherein a receptacle is provided for the positionally fixed receptacle of the additional non-contact distance measuring device on the test chamber or the test chamber base, and wherein, for the positionally fixed receptacle of the receptacle, in particular a force-fit connection of the receptacle to the test chamber or the test chamber base or at least one clamping means is provided.

16. The test chamber assembly according to claim 15, wherein the receptacle comprises a tubular extension of the test chamber base.

17. A capillary rheometer comprising a test chamber assembly having:
a test chamber which can be filled with a test mass and is heatable, having a test chamber base;
a die arranged in the test chamber so as to be linearly displaceable, including a die rod and a die tip connected to a first end of the die rod, which applies pressure to the test material and has a die base;
a displacement device receiving a second end of the die rod for displacing the die within the test chamber in the direction of the test chamber base; and
a non-contact distance measuring device arranged in the displacement device, decoupled from the die and movable with the displacement device, for detecting die elongation,
wherein a bore extending in the direction of a longitudinal axis of the die rod between the die base and the second end is formed in the die rod, and wherein a reflective surface facing the non-contact distance measuring device for a measurement signal emitted by the non-contact distance measuring device through the die rod, and the non-contact distance measuring device includes a sensor arranged relative to the reflection surface for the contactless detection of the measurement signal reflected from the reflective surface to the sensor.

18. The capillary rheometer according to claim 17, wherein the test chamber base is formed to be closed or provided with a closable extrusion nozzle.

19. The test chamber assembly according to claim 2, wherein the sensor has a measurement resolution of about 0.005 mm.
